(19) United States
(12) Patent Application Publication
(10) Pub. No.: US 2018/0354766 A1
(43) Pub. Date: Dec. 13, 2018

(54) BOTTLING MACHINE COMPRISING AT LEAST TWO MICRO-CAROUSELS FOR ADDITIVE FLUIDS, AND RELATED METHOD

(71) Applicant: NESTEC S.A., Vevey (CH)

(72) Inventors: Andrea Comin, Vittel (FR); Damien Kannengiesser, Golbey (FR)

(73) Assignee: NESTEC S.A., Vevey (CH)

(21) Appl. No.: 15/781,230

(22) PCT Filed: Dec. 6, 2016
(86) PCT No.: PCT/EP2016/079958

§ 371 Date: Jun. 4, 2018

(30) Foreign Application Priority Data
Dec. 7, 2015 (EP) 15198163.6

(51) Int. Cl. B67C 3/02; B67C 3/00; B67C 7/00; B67C 3/26

(52) U.S. Cl. CPC B67C 3/023; B67C 3/007; B67C 2003/2685; B67C 3/2622; B67C 2007/006; B67C 7/002

(57) ABSTRACT

The invention relates to a bottling machine comprising a carousel (1) for filling containers with a main liquid material, wherein said bottling machine comprises a first micro-carousel (61) for introducing a first additive fluid into transferred containers; and a second micro-carousel (62) for introducing a second additive fluid into transferred containers. The invention also relates to a method for producing packs of a given number of containers filled with at least two different products within the same pack.

### FIELD OF THE INVENTION

The present invention concerns the technical field of industrial facilities for filling containers such as bottles with a liquid product, and more particularly bottling machines.

In the present document, the invention is described in relation with bottle filling. The term bottle designates any type of bottle of any size, from flacon to large bottles. Although the invention is more particularly described in the present document in relation to bottle filling, it encompasses filling of other containers such as for example cans or cardboard containers.

It relates more particularly to the filling with an additive fluid of a bottle (or another container) filled or to be filled with another liquid material. In the food industry, the additive may typically be an edible flavouring concentrate, and the main liquid material in the bottle may be any liquid beverage product base such as water, soda, lemonade, a soup, and so on.

The invention relates more particularly to industrial machines comprising a rotary filling wheel, also called filling carousel.

### BACKGROUND OF THE INVENTION

A common way to fill bottles or other containers in an industrial facility uses a bottling machine comprising a rotary filling wheel or carousel. The carousel is essentially a rotary wheel or rotor of large diameter comprising holding and filling arrangements on its perimeter.

Bottles are brought to the holding means of the carousel, and then filled while the carousel rotates over a certain rotation angle. The bottling machine comprises at least a first transfer wheel to supply bottles to transfer from a bottle stock to the carousel, and at least a second transfer wheel to transfer filled bottles to a further device comprised in the filling machine or outside the machine. A transfer wheel is a wheel whose sole function is to receive a container from a first apparatus or another transfer wheel and, by revolution about its axis, transfer the container to a second apparatus or another transfer wheel.

The machine may in particular comprise a device for capping the bottle after it is filled. Such a “capper” may be essentially another rotary wheel having holding and capping arrangements on its perimeter.

The preparation of liquid, for example in the food industry, may require incorporating a small quantity of an additive fluid into a bottle, empty or full of a main liquid material. For example, an aroma, which is a liquid having a highly concentrate flavour, may be introduced in a bottle, before or after the bottle is filled with water, to create flavoured water.

The additive may be introduced into the bottle according to two known alternatives. First, an independent micro-dosing machine (“microdoser”) may be added right upstream the bottling machine. The microdoser usually comprises a small filling carousel with filler valves installed on it to introduce the additive into the bottles while they travel through a certain angle of the carousel. In other words, introducing an additive fluid into a bottle is performed like the filling of the bottle in a bottling machine, but using a smaller carousel and dosing valves configured to dose smaller volumes.

However, it is not always possible to add an independent microdoser upstream of a bottling machine. A microdoser takes up space, and available space is limited in industrial environment.

Adding a new machine in a pre-existing installation is often impossible or very difficult. For example, in plastic water bottle production facilities, the bottling machine inlet—where the bottles enter the bottling machine—is generally situated right at the outlet of a blower in which the bottles are formed. Adding a microdoser implies separating the blower and the bottling machine, and placing the microdoser between them, which is often impossible or entails big changes in the whole production line.

Another known solution to introduce a small quantity of liquid into a bottle is the use of a system called “static microdoser”. A static microdoser consists of a fixed device configured to generate a jet of pressurized additive fluid when a bottle mouth passes under a nozzle of the microdoser. The static microdoser may typically be installed over a transfer wheel of the bottling machine. Such a device is typically used for introducing a very small quantity of liquid nitrogen into beverage bottles. However, the quantity of liquid that may be introduced with such a device is very limited, due to the very limited time available for injection defined by the passage of the opening (mouth) of a bottle under the injection nozzle. Use of a static microdoser is thus limited to the introduction of very small quantity of additives into a bottle. Furthermore, a small misalignment of a static microdoser with the mouth of the bottle (e.g. due to a bad synchronization of the injection) may cause the injected fluid to fall on the bode shoulders. This may be acceptable only if the fluid evaporate without letting any trace on the bottle, as liquid nitrogen does. For these reasons, a static microdoser cannot be used, for example, to introduce an aroma for producing flavoured drinkable water.

In addition, it may be desirable to produce packs of containers filled with different products based on a same main liquid material, for example a pack comprising bottles of flavoured water having different flavours (for example a six-pack of flavoured water bottles, comprising three lemon flavoured water bottles and three strawberry flavoured water bottles, or any other flavours). Currently, producing such a pack comprising different products requires obtaining the filled containers from as many bottling lines as the number of different products to be packaged and to pick the products to be gathered in the pack from output stocks of the bottling lines. This is complex, and requires a lot of space.

The invention, aims to provide a device for introducing several additives in the same bottling line that solves at least one of the previously cited drawbacks.

### SUMMARY OF THE INVENTION

The objective set out above is met with a bottling machine comprising a container inlet, a container outlet, a carousel for filling the containers with a main liquid material, a plurality of transfer wheels for transferring containers from the container inlet to the carousel and from the carousel to the container outlet. The bottling machine comprises a first micro-carousel for introducing a first additive fluid into transferred containers, and a second micro-carousel for introducing a second additive fluid into transferred containers.

This makes it for example possible by an appropriate configuration of the machine and/or an appropriate control of the dosing valves of micro-carousel, to introduce for example an additive into certain containers, and another additive into the remaining containers. Different products, for example flavoured waters of different flavour, may thus be produced in the same machine, in a predetermined sequence. Alternatively, the production of a product may be switch to the production of another product (based on the same main liquid material) almost instantaneously.

Each micro-carousel may comprise a plurality of additive introduction nozzles, each nozzle being fed by an additive line comprising a dosing valve, and the bottling machine may be configured to operate each dosing valve independently, to fill with additive fluid only some selected containers traveling on each micro-carousel.

The bottling machine may further be configured to introduce, according to a defined cyclical sequence, the first additive fluid, the second additive fluid, both first and second additive fluids or no additive fluid into the containers traveling through the bottling machine.

In an embodiment, the cyclical sequence may consist of introducing the first additive fluid into a first container of two successive containers, and introducing the second additive fluid into a second container of said two successive containers. In another embodiment, the cyclical sequence may consist of:
for a series of three successive containers, introducing the first additive fluid into one container, introducing the second additive fluid into another container, and leaving the remaining container without additive fluid; or
for a series of three successive containers, introducing the first additive fluid into one container, introducing the second additive fluid into another container, introducing both first and second additive fluids into the remaining container.

In still another embodiment, the cyclical sequence may have a length of six or twelve containers.

The first micro-carousel and the second micro-carousel may be upstream of the filling carousel. The first micro-carousel and the second micro-carousel may be downstream of the filing carousel and upstream of a capper wheel of the bottling machine. The first micro-carousel and the second micro-carousel may be respectively downstream of the filing carousel and upstream of the filling carousel of the bottling machine.

The first micro-carousel and the second micro-carousel may be adjacent.

Each micro-carousel may comprise holding sites where the containers are held during transfer and the possible introduction of additive fluid, and an additive introduction nozzle is situated above each holding site of the micro-carousel. Each nozzle of at least one of the first micro-carousel or second micro-carousel may be offset from a central axis of a corresponding holding site, said central axis passing through the centre of an opening of a container held in the holding site. In this case, the offset value and direction is adapted so that, when a container passes from the first micro-carousel to the adjacent second micro-carousel, a nozzle of the first micro-carousel and a nozzle of the second micro-carousel are both positioned over the opening of the container, without coming into contact.

When at least one of the first or second micro-carousel is adjacent to the filling carousel, said at least one micro-carousel adjacent to the filling carousel may comprise holding sites where the containers are held during transfer and the possible introduction of additive fluid, and an additive introduction nozzle is situated above each holding site of the micro-carousel, each nozzle of said micro-carousel being offset from a central axis of a corresponding holding site, said central axis passing through the centre of an opening of a container held in the holding site. In this case, the offset value and direction may be adapted so that the nozzle does not contact a filling head of the filling carousel when a container is transferred from the micro-carousel to the carousel or from the carousel to the micro-carousel.

In alternatives embodiments, the bottling machine may comprise three, four, five or six micro-carousels.

The invention also relates to a method for producing packs of a given number of containers filled with at least two different products within the same pack, comprising:
providing a bottling machine as previously described, wherein each micro-carousel comprises a plurality of additive introduction nozzles, each nozzle being fed by an additive line comprising a dosing valve, and the bottling machine being configured to operate each dosing valve independently, to fill with additive fluid only some selected containers traveling on each micro-carousel, the bottling machine being further be configured to introduce the first additive fluid, the second additive fluid, both first and second additive fluids, or no additive fluid, into the containers traveling through the bottling machine according to a defined cyclical sequence;
defining a cyclical sequence for introducing the first additive fluid, the second additive fluid, both first and second additive fluid, or no additive fluid, into the containers traveling through the bottling machine, said sequence being defined on said given number of successive containers;
providing empty containers at the container inlet of the bottling machine;
gathering the filled containers that exit the bottling machine, in the order in which they exit the bottling machine through the container outlet, in packs of the given number of containers.

The method may further comprise marking the containers with distinctive markings, according to the cyclical sequence. The containers may thus be marked according to their respective content.

In the previously described method, the containers may be bottles, and preferably PET bottles.

### BRIEF DESCRIPTION OF THE DRAWINGS

Additional features and advantages of the present invention are described in, and will be apparent from, the description of the presently preferred embodiments which are set out below with reference to the drawings in which:

FIG. 1 is a schematic view of a bottling machine according to the prior art;

FIG. 2 is a general view of a device for introducing an additive fluid into a container according to an embodiment of the invention;

FIG. 3 is a schematic partial view in section of an example of micro-carousel that may be used in an embodiment of the invention.

FIG. 4 is a schematic partial top view of the machine of FIG. 2;

FIG. 5 is a schematic partial view of a fluid outlet of a device for introducing an additive fluid into a container according to an embodiment of the invention and its immediate surroundings when a container is transferred to or from an adjacent filling carousel.

### DETAILED DESCRIPTION OF THE INVENTION

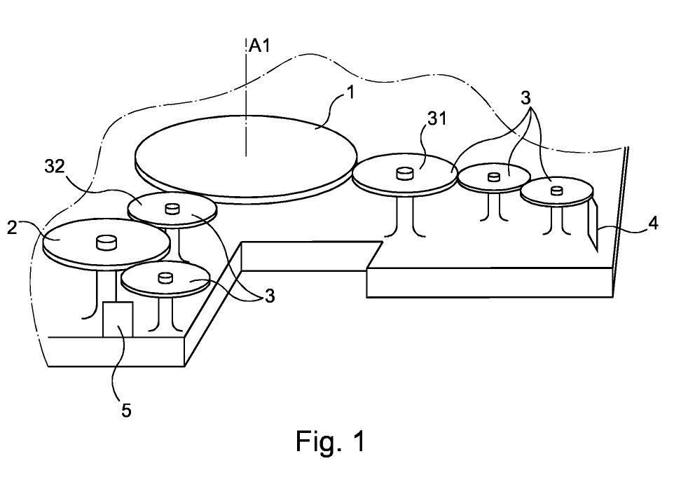

The machine schematically illustrated in FIG. 1 is a bottling machine for bottling containers such as bottles or cardboard containers for example.

More particularly, FIG. 1 represents a bottling machine for plastic bottles (PET bottles—for Polyethylene terephthalate bottles—). The represented bottling machine has a typical design of the machines used for filling plastic bottles with mineral water, soda, or other still or sparkling beverage.

The machine comprises a filling carousel 1 that rotates around a vertical machine axis A1. On the periphery of the carousel, a number of filling positions is formed. At each filling position, the carousel comprises a means for holding a bottle, for example a fork or a gripper for holding a bottle under its opening (bottle mouth). At each filling position, the carousel also comprises a filling head for filling the bottle with a main liquid material.

Each filling head, comprising a discharge opening, is fed with the main liquid material with which the bottles are to be filled via a fluid line comprising a dosing valve. The fluid line is preferably in communication with a manifold feeding the lines of the carousel with the main liquid material being bottled.

The dosing valve of each line may be controlled for example via an actuator device. The valve may be opened for liquid material delivery, or closed to stop the delivery when a bottle is sufficiently filled.

Several solutions may be implemented to determine when the filling must be stopped. The valve of each line may be calibrated to deliver a precise liquid quantity in a predefined time period. A flow meter may be provided in each line for liquid material delivery. A probe may be provided, immersed in the liquid being bottled. When the desired filling volume is reached, a control device closes the dosing valve.

The represented machine also comprises a capping wheel or capper 2, configured to seal the bottles with a cap after they have been filled when held on the carousel.

The represented machine comprises several transfer wheels 3 to transport the bottles to be bottled from a container inlet 4 to the filling carousel 1, from the filling carousel 1 to the capper 2, and from the capper 2 to a container outlet 5.

In particular, the bottles to be filled are each fed to a respective position of the filling carousel 1 by means of an upstream transfer wheel 31. The filled bottles are removed from the filling positions on a downstream transfer wheel 32 and transported to the capper 2, for example.

After a bottle has been transferred from the upstream transfer wheel 31 to a filling position, in a specified angular range of the rotational movement of the rotor 1, the liquid valve is opened to begin this filling phase. The volume to be filled is defined by closing the dosing valve when a specified volume of the liquid being bottled has been dispensed into the bottle provided at the respective filling position.

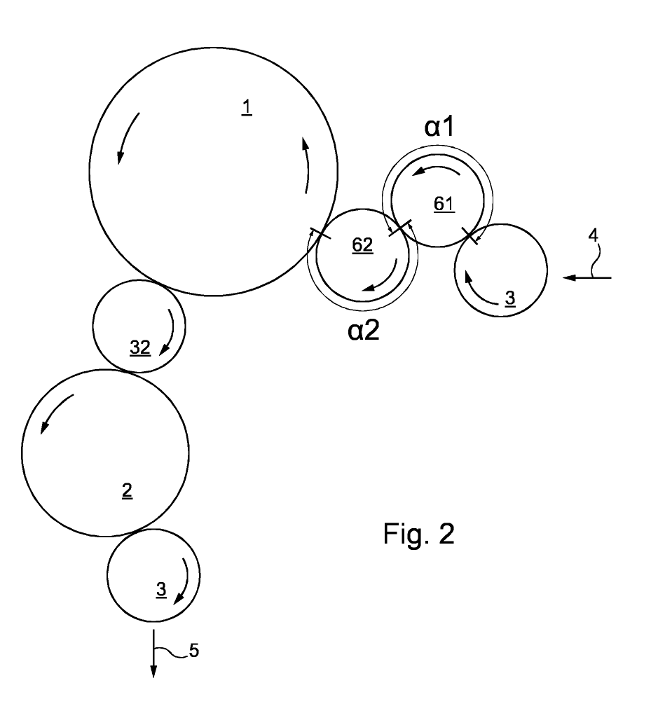

FIG. 2 is a general top view of a bottling machine according to an embodiment of the invention. The represented bottling machine has the same general architecture of the bottling machine of FIG. 1.

The machine comprises a filling carousel 1, comprising a plurality of filing heads at its periphery for filling containers with a main liquid material. The represented machine also comprises a capper 2.

The represented machine comprises several transfer wheels 3 to transport the containers (e.g. bottles) to be bottled from a container inlet 4 to the filling carousel 1, from the filling carousel 1 to the capper 2, and from the capper 2 to a container outlet 5. An upstream transfer wheel 31 feed the carousel 1 with containers to be filled, and a downstream transfer wheel 32 removes the filled containers from said carousel 1. In the represented embodiment, the downstream transfer wheel 32 also feeds the capper 2 with filled containers.

The bottling machine comprises a first micro-carousel 61 for introducing a first additive fluid into containers that it transfers, i.e. all or some containers processed in the bottling machine. The bottling machine also comprises a second micro-carousel 62 for introducing a second additive fluid into containers that it transfers, i.e. all or some containers processed in the bottling machine.

In other embodiments of the invention, the bottling machine may comprise more than two micro-carousels.

Additive fluid should be understood as designating a fluid which is correspond to 0.1% to 5%, preferably 0.1% to 1%, of the total fluid content of the bottle or container.

As non-exhaustive examples additive fluid can be a flavour or aroma (for example orange, peach, lemon . . . ), a tea or coffee extract, a fruit juice, a minerals mother solution . . . .

Additionally, the additive fluid can be liquid carbon dioxide or liquid nitrogen according to the required use as known by the skilled person.

Each micro-carousel 61, 62 is configured to introduce a small quantity of additive fluid into containers. A micro-carousel may have the same general configuration of the filling carousel 1, at a reduced scale adapted to dose smaller fluid volumes with precision.

The introduction of an additive fluid may be performed during the entire travel time of a bottle on the micro-carousel. Because the rotation speed of the micro-carousel is constant, the travel time of a container is proportional to the rotation angle of the transfer wheel between the time a bottle enters a holding site of the micro carousel and the time it leaves said holding site. A first additive fluid may be introduced in a container by the first micro-carousel 61 over the rotation angle α1. A second additive fluid may be introduced in a container by the second micro-carousel 62 over the rotation angle α2. This provides much more time for introducing an additive fluid into a container than the time available when a static microdoser is used. More time for introducing the additive fluid makes it possible to introduce more additive fluid, and/or a more precise quantity of additive fluid.

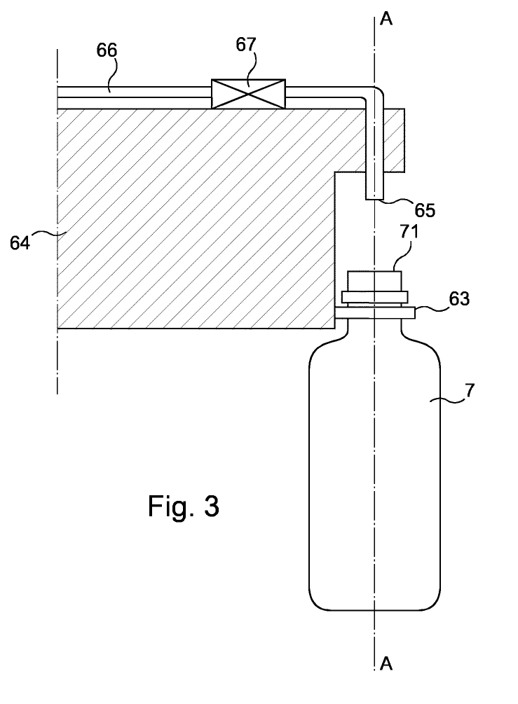

FIG. 3 is a schematic partial view in section of an example of micro-carousel 61, 62 that may be used in an embodiment of the invention. The micro carousel comprises a number of holding sites 63 at the periphery of its body 64. The body 64 may for example have a circular shape or star shape.

A holding site 63 is configured to hold a container 7, e.g. by grasping said container. Some or all holding sites 63 of the micro-carousel are provided with a nozzle 65 for introducing an additive fluid into a held container 7. Each nozzle 65 is fed with additive fluid by a fluid line 66. The fluid line is preferably in communication with a manifold (not represented) feeding the fluid lines 66 of the micro-carousel 61, 62 with an additive fluid. Preferably, one manifold is provided for each micro-carousel used on a bottling machine, making it possible to have a different additive fluid into each manifold.

Each fluid line 66 comprises a dosing valve 67. The dosing valve of each fluid line 66 may be controlled for example via an actuator device. The dosing valve 67 may be opened for additive fluid delivery, or closed to stop the delivery when the desired quantity of fluid additive has been introduced in a container 7.

To determine when the additive fluid delivery must be stopped, the dosing valve of each line may be calibrated to deliver a precise liquid quantity in a predefined time period, or a flow meter may be provided in each line for liquid material delivery.

Providing two micro-carousels (or more) for introducing an additive fluid in the same bottling machine makes it possible, by appropriate control of the dosing valves of micro-carousel, to introduce for example an additive into certain containers, and another additive into the remaining containers. Different products, for example flavoured waters of different flavour, may thus be produced in the same machine, in a predetermined sequence. This makes it possible, for example, to pack directly in the same package different products output by the same bottling machine.

Electronic or computer based control means may be provided to control the opening of the dosing valves of first and second micro-carousels (and of any other micro-carousel of the bottling machine) according to a defined cyclical sequence to obtain bottles of different product in a known order at the container outlet 5 of the bottling machine. For example, a basic sequence may consists of introducing the first additive fluid into a first container of two successive containers, and introducing the second additive fluid into a second container of said two successive containers. Other sequences may have a length of three containers, and consist of: introducing the first additive fluid into one container, introducing the second additive fluid into another container, and leaving the remaining container without additive fluid; or introducing the second additive fluid into another container, introducing both first and second additive fluids into the remaining container. The cyclical sequence may have a length of four containers. The cyclical sequence may have a length of six or twelve containers. This may be advantageous in that a six-pack is a very common pack size in the beverage and food industries.

In a cyclical sequence of twelve containers, a first additive fluid may be introduced in the six first containers, and a second additive fluid may be introduced in the six last containers of the sequence.

As it can be seen in FIG. 2, in the represented embodiment the first micro-carousel 61 and the second micro carousel 62 are adjacent, which means that they are directly successive in the bottling machine. In other words, the containers 7 are directly transferred from the first micro-carousel 61 to the second micro carousel 62.

Such a configuration may be problematic in that it may create mechanical interferences between the nozzles 65 of the first micro-carousel 61 and the nozzles of the second micro carousel 62, when a holding site 63 of said first micro-carousel 61 and a holding site of the second micro carousel 62 coincide (at the instant when a container is transferred from the first micro-carousel 61 to the second micro-carousel 62).

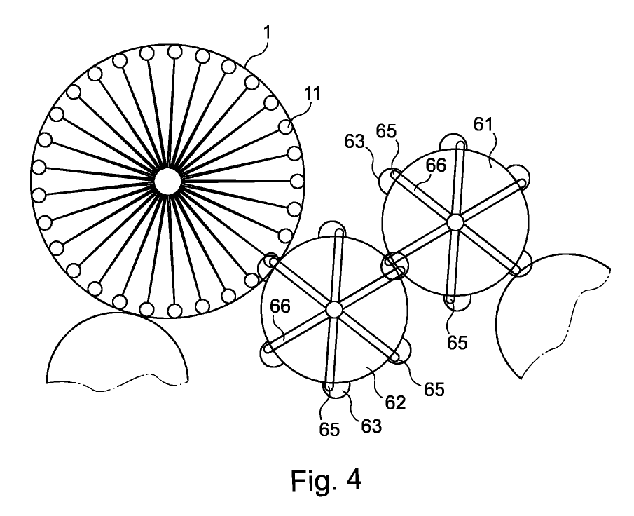

FIG. 4 is a schematic partial top view of the machine of FIG. 2, which illustrates how the mechanical interferences between the first and the second micro-carousels may be avoided.

Regarding possible mechanical interferences between the nozzles 65 of the first and second micro-carousels 61, 62, the respective nozzles of the first and second micro-carousels 61, 62 are preferably offset from a central axis A of the holding site, in opposite directions. The central axis A of a holding site is defined as being the axis passing through the centre of an opening of a container held in the holding site, and is shown in FIG. 3. In some cases, only one of the two micro-carousels may have offset nozzles. The offset value or values are chosen to avoid any contact or interference between the nozzles. More particularly, the offset value and direction are chosen so that, when a container 7 passes from the first micro-carousel 61 to the adjacent second micro-carousel 62, a nozzle 65 of the first micro-carousel 61 and a nozzle 65 of the second micro-carousel 62 are both positioned over the opening 71 of the container, without coming into contact.

The offset may be defined by the distance or the angle between the support the central axis A of a holding site 63 and the centre of the outlet of a corresponding nozzle 65.

In the represented embodiment, the second micro-carousel 62 is also adjacent to the filling carousel 1.

Such a configuration may be problematic in that it may create mechanical interferences between the nozzles 65 of the second micro-carousel 62 and the filing heads 11 or another part of the carousel 1 when a container is transferred from the micro-carousel to the carousel 1 (or, in another embodiment, from the carousel 1 to a micro-carousel).

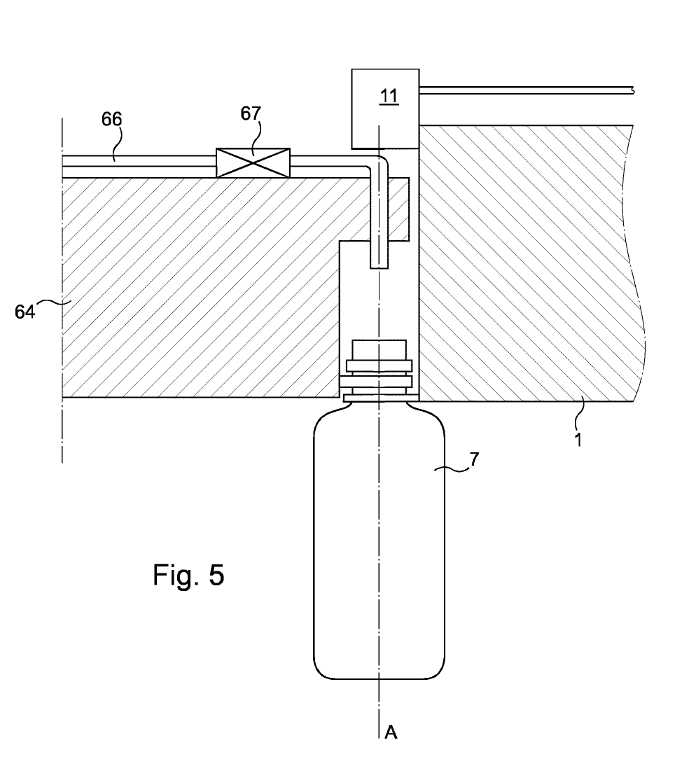

In such a case, and as shown in FIG. 5, the micro-carousel 6 is positioned at a different level compared to the filling heads 11 of the carousel 1, thereby avoiding any contact with a filing head 11 when a container 7 is transferred from the micro-carousel 6 to the carousel 1 or form the carousel 1 to the micro-carousel 6. In the configuration shown on FIG. 5 the dosing system is positioned between the neck of the container 7 and the filling head.

It should be understood that various changes and modifications to the presently preferred embodiments described herein will be apparent to those skilled in the art. Such changes and modifications can be made without departing from the spirit and scope of the present invention and without losing its attendant advantages. It is therefore intended that such changes and modifications be covered by the appended claims.

For example, many positions in the bottling machine, upstream or downstream of the filling carousel, may be contemplated for the micro-carousels. The bottling machine may be provided with more than two micro-carousels, for example three, four, five, or six micro-carousels.

For example, the above-described structures can be modified to be used in similar container-handling applications for containers, such as bottles and cans, of various shapes and sizes, and for various types of beverages.

1. A bottling machine comprising a container inlet, a container outlet, a carousel for filling the containers with a main liquid material, a plurality of transfer wheels for transferring containers from the container inlet to the carousel and from the carousel to the container outlet, and
the bottling machine comprises a first micro-carousel for introducing a first additive fluid into transferred containers; and a second micro-carousel for introducing a second additive fluid into transferred containers.

2. The bottling machine according to claim 1, wherein each micro-carousel comprises a plurality of additive introduction nozzles, each nozzle being fed by an additive line comprising a dosing valve, and wherein the bottling machine is configured to operate each dosing valve independently, to fill with additive fluid only some selected containers traveling on each micro-carousel.

3. The bottling machine according to claim 2, wherein the bottling machine is configured to introduce according to a defined cyclical sequence the first additive fluid, the second additive fluid, both first and second additive fluids, or no additive fluid into the containers traveling through the bottling machine.

4. The bottling machine according to claim 3, wherein the cyclical sequence consists of introducing the first additive fluid into a first container of two successive containers, and introducing the second additive fluid into a second container of said two successive containers.

5. The bottling machine according to claim 3, wherein the cyclical sequence consist of:
for a series of three successive containers, introducing the first additive fluid into one container, introducing the second additive fluid into another container, and leaving the remaining container without additive fluid; or
for a series of three successive containers, introducing the first additive fluid into one container, introducing the second additive fluid into another container, introducing both first and second additive fluids into the remaining container.

6. The bottling machine according to claim 3, wherein the cyclical sequence has a length of six or twelve containers.

7. The bottling machine according to claim 1, wherein the first micro-carousel and the second micro-carousel are upstream of the filling carousel.

8. The bottling machine according to claim 1, wherein the first micro-carousel and the second micro-carousel are downstream of the filing carousel and upstream of a capper wheel of the bottling machine.

9. The bottling machine according to claim 1, wherein the first micro-carousel and the second micro-carousel are respectively downstream of the filing carousel and upstream of the filling carousel of the bottling machine.

10. The bottling machine according to claim 1, wherein the first micro-carousel and the second micro-carousel are adjacent.

11. The bottling machine according to claim 10, wherein each micro-carousel comprises holding sites where the containers are held during transfer and the possible introduction of additive fluid, wherein an additive introduction nozzle is situated above each holding site of the micro-carousel, each nozzle of at least one of the first micro-carousel or second micro-carousel being offset from a central axis of a corresponding holding site, the central axis passing through the center of an opening of a container held in the holding site, the offset value and direction being adapted so that, when a container passes from the first micro-carousel to the adjacent second micro-carousel, a nozzle of the first micro-carousel and a nozzle of the second micro-carousel are both positioned over the opening of the container, without coming into contact.

12. The bottling machine according to claim 1, wherein it comprises at least three micro-carousels.

13. A method for producing packs of a given number of containers filled with at least two different products within the same pack, comprising:
providing a bottling machine comprising a container inlet, a container outlet, a carousel for filling the containers with a main liquid material, a plurality of transfer wheels for transferring containers from the container inlet to the carousel and from the carousel to the container outlet, and the bottling machine comprises a first micro-carousel for introducing a first additive fluid into transferred containers, and a second micro-carousel for introducing a second additive fluid into transferred containers;
defining a cyclical sequence for introducing the first additive fluid, the second additive fluid, both first and second additive fluid, or no additive fluid, into the containers traveling through the bottling machine, said sequence being defined on said given number of successive containers;
providing empty containers at the container inlet of the bottling machine; and
gathering the filled containers that exit the bottling machine, in the order in which they exit the bottling machine through the container outlet, in packs of the given number of containers.

14. The method for producing packs of a given number of containers according to claim 13, wherein the method comprises marking the containers with distinctive markings, according to the cyclical sequence.

15. The method according to claim 13, wherein the containers are bottles.
